(19) United States
(12) Patent Application Publication
(10) Pub. No.: US 2022/0238093 A1
(43) Pub. Date: Jul. 28, 2022

(54) ACTIVE NOISE CONTROL DEVICE

(71) Applicant: HONDA MOTOR CO., LTD., Tokyo (JP)

(72) Inventors: Toshio INOUE, WAKO-SHI (JP); Xun WANG, WAKO-SHI (JP)

(21) Appl. No.: 17/584,863

(22) Filed: Jan. 26, 2022

(30) Foreign Application Priority Data
Jan. 28, 2021 (JP) 2021-012292

(51) Int. Cl. G10K 11/178

(52) U.S. Cl. CPC G10K 11/17854; G10K 2210/1282; G10K 11/17883; G10K 11/17823

(57) ABSTRACT

An active noise control device performs signal processing on a basic signal corresponding to a control target frequency by a control filter, which is an adaptive notch filter, to generate a control signal that controls a speaker, sequentially and adaptively updates coefficients of the control filter, compares a magnitude of a primary path filter with a magnitude of the control filter, and determines whether the state of the control filter is unstable or not.

### CROSS-REFERENCE TO RELATED APPLICATIONS

This application is based upon and claims the benefit of priority from Japanese Patent Application No. 2021-012292 filed on Jan. 28, 2021, the contents of which are incorporated herein by reference.

### BACKGROUND OF THE INVENTION

### Field of the Invention

The present invention relates to an active noise control device.

### Description of the Related Art

JP 2008-239098 A discloses an active noise control device. This active noise control device generates a control signal for causing a speaker to output a canceling sound to cancel noise transmitted from a propeller shaft to the inside of a vehicle. The control signal is generated by performing signal processing on a basic signal using an adaptive filter. The basic signal is generated based on the rotational frequency of the propeller shaft. The adaptive filter is updated based on an error signal output by a microphone provided in the vehicle and a reference signal generated by correcting a basic signal with a correction value.

### SUMMARY OF THE INVENTION

In the active noise control device disclosed in JP 2008-239098 A, a transfer characteristic of a canceling sound between the speaker and the microphone is used as the correction value. This correction value is a transfer characteristic measured in advance. Therefore, there is a possibility that the noise cannot be reduced when the transfer characteristic changes.

An object of the present invention is to solve the aforementioned problem.

An active noise control device according to one aspect of the present invention performs active noise control for controlling a speaker based on an error signal that changes in accordance with a synthetic sound of noise transmitted from a vibration source and a canceling sound output from the speaker to cancel the noise, and includes a basic signal generating unit configured to generate a basic signal corresponding to a control target frequency, a control signal generating unit configured to perform signal processing on the basic signal by a control filter, which is an adaptive notch filter, to generate a control signal that controls the speaker, a first estimated cancellation signal generating unit configured to perform signal processing on the control signal by a secondary path filter, which is an adaptive notch filter, to generate a first estimated cancellation signal, an estimated noise signal generating unit configured to perform signal processing on the basic signal by a primary path filter, which is an adaptive notch filter, to generate an estimated noise signal, a reference signal generating unit configured to perform signal processing on the basic signal by the secondary path filter to generate a reference signal, a second estimated cancellation signal generating unit configured to perform signal processing on the reference signal by the control filter to generate a second estimated cancellation signal, a first virtual error signal generating unit configured to generate a first virtual error signal from the error signal, the first estimated cancellation signal, and the estimated noise signal, a second virtual error signal generating unit configured to generate a second virtual error signal from the estimated noise signal and the second estimated cancellation signal, a secondary path filter coefficient updating unit configured to sequentially and adaptively update a coefficient of the secondary path filter based on the control signal and the first virtual error signal in a manner that a magnitude of the first virtual error signal is minimized, a control filter coefficient updating unit configured to sequentially and adaptively update a coefficient of the control filter based on the reference signal and the second virtual error signal in a manner that a magnitude of the second virtual error signal is minimized, and a state determination unit configured to compare a magnitude of the primary path filter with a magnitude of at least the control filter to determine whether a state of the control filter is unstable.

The active noise control device of the present invention can reduce noise even if the transfer characteristic changes.

The above and other objects, features, and advantages of the present invention will become more apparent from the following description when taken in conjunction with the accompanying drawings in which a preferred embodiment of the present invention is shown by way of illustrative example.

### BRIEF DESCRIPTION OF THE DRAWINGS

FIG. 1 is a diagram illustrating an outline of active noise control executed by an active noise control device;

FIG. 2 is a block diagram of an active noise control device using a method that was proposed by the present inventors and the like;

FIG. 3 is a block diagram of an active noise control device;

FIG. 4 is a diagram illustrating updating of a filter coefficient.

FIG. 5 is a flowchart illustrating a flow of a filter coefficient update process;

FIG. 6 is a flowchart illustration a flow of a filter state determination process;

FIG. 7 is a block diagram of a signal processing unit;

FIG. 8 is a block diagram of a signal processing unit;

FIG. 9 is a flowchart illustrating the flow of a filter state determination process; and

FIG. 10 is a block diagram of an active noise control device.

### DESCRIPTION OF THE INVENTION

### First Embodiment

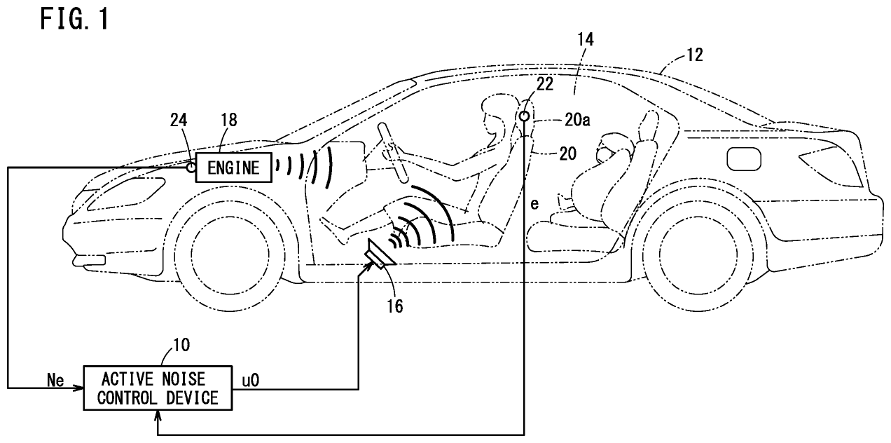

FIG. 1 is a diagram illustrating an outline of active noise control executed by an active noise control device 10.

The active noise control device 10 causes a speaker 16 provided in a vehicle compartment 14 of a vehicle 12 to output a canceling sound. This reduces a muffled sound of an engine 18 (hereinafter referred to as noise) that is transmitted to a vehicle occupant in the vehicle compartment 14 due to vibration of the engine 18. The active noise control device 10 generates a control signal u0 based on the error signal e and an engine rotational speed Ne. The error signal e is a signal output from a microphone 22 provided on a headrest 20a of a seat 20 provided in the vehicle compartment 14. A synthetic sound (hereinafter, referred to as canceling error noise) of the canceling sound and the noise is input to the microphone 22. The engine rotational speed Ne is detected by an engine rotational speed sensor 24. The control signal u0 is a signal for causing the speaker 16 to output the canceling sound.

### [Conventional Active Noise Control Device]

Conventionally, an active noise control device using an adaptive notch filter (for example, a single-frequency adaptive notch (SAN) filter) having a small amount of computational processing has been proposed.

In the conventional active noise control device, first, a basic signal x having a frequency (control target frequency) of noise to be canceled is generated. The active noise control device performs signal processing on the generated basic signal x by a control filter W, which is an adaptive notch filter. Thus, a control signal u0 is generated. The active noise control device controls the speaker 16 by the control signal u0 to output a canceling sound for canceling the noise from the speaker 16.

The control filter W is updated by an adaptive algorithm (for example, an LMS (Least Mean Square) algorithm) such that the error signal e output from the microphone 22 is minimized.

A transfer characteristic C is present in a sound transfer path from the speaker 16 to the microphone 22. Therefore, it is necessary to consider this transfer characteristic C for updating the control filter W. The transfer characteristic C includes electronic circuit characteristics of the speaker 16 and the microphone 22. The conventional active noise control device identifies the transfer characteristic C as a filter C\hat{ } in advance. The basic signal x corrected by the filter C\hat{ } is used to update the control filter W. Such a control system is called a filtered-x type.

The filter C\hat{ } is a fixed filter identified in advance. Thus, when the transfer characteristic C has been changed, the phase characteristic of the filter C\hat{ } and the phase characteristic of the transfer characteristic C may be significantly deviated from each other. In this case, there is concern that when the control filter W is updated, the control filter W may diverge. Therefore, there is also concern that noise may be amplified by the canceling sound output from the speaker 16, or that an abnormal sound may be generated.

Therefore, the present inventors have proposed a method in which the filter C\hat{ } can follow a change in the transfer characteristic C during active noise control. In this method, it is not necessary to identify the transfer characteristic C in advance. The present invention is a further improvement of the method that was already proposed by the present inventors. An active noise control device 100 using the method already proposed by the present inventors will be schematically described below.

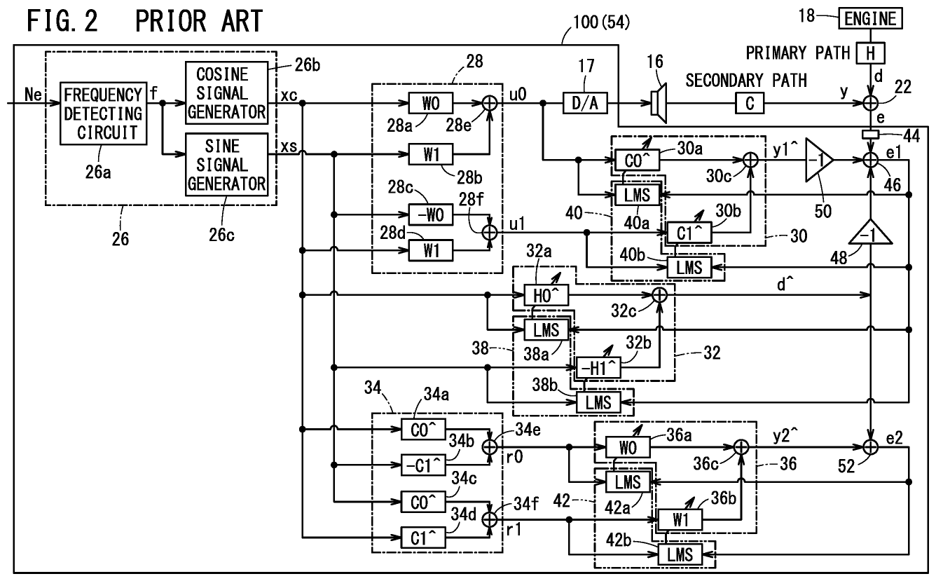

FIG. 2 is a block diagram of the active noise control device 100 using the method proposed by the present inventors. The transfer path of the sound from the engine 18 to the microphone 22 is hereinafter referred to as a primary path. Further, the transfer path of the sound from the speaker 16 to the microphone 22 is hereinafter referred to as a secondary path.

The active noise control device 100 includes a basic signal generating unit 26, a control signal generating unit 28, a first estimated cancellation signal generating unit 30, an estimated noise signal generating unit 32, a reference signal generating unit 34, a second estimated cancellation signal generating unit 36, a primary path filter coefficient updating unit 38, a secondary path filter coefficient updating unit 40, and a control filter coefficient updating unit 42.

The basic signal generating unit 26 generates basic signals xc and xs based on the engine rotational speed Ne. The basic signal generating unit 26 includes a frequency detecting circuit 26a, a cosine signal generator 26b, and a sine signal generator 26c.

The frequency detecting circuit 26a detects a control target frequency f. The control target frequency f is a vibration frequency of the engine 18 detected based on the engine rotational speed Ne. The cosine signal generator 26b generates the basic signal xc (=cos(2πft)) which is a cosine signal of the control target frequency f. The sine signal generator 26c generates the basic signal xs (=sin(2πft)) which is a sine signal of the control target frequency f. Here, t indicates time.

The control signal generating unit 28 generates control signals u0 and u1 based on the basic signals xc and xs. The control signal generating unit 28 includes a first control filter 28a, a second control filter 28b, a third control filter 28c, a fourth control filter 28d, an adder 28e, and an adder 28f.

In the control signal generating unit 28, a SAN filter is used as a control filter W. The control filter W has a filter W0 for the basic signal xc and a filter W1 for the basic signal xs. The control filter W is optimized by updating a coefficient W0 of the filter W0 and a coefficient W1 of the filter W1 in the control filter coefficient updating unit 42 described later.

The first control filter 28a has the filter coefficient W0. The second control filter 28b has the filter coefficient W1. The third control filter 28c has a filter coefficient −W0. The fourth control filter 28d has a filter coefficient W1.

The basic signal xc corrected by the first control filter 28a and the basic signal xs corrected by the second control filter 28b are added by the adder 28e to generate the control signal u0. The basic signal xs corrected by the third control filter 28c and the basic signal xc corrected by the fourth control filter 28d are added by the adder 28f to generate the control signal u1.

The control signal u0 is converted into an analog signal by a digital-to-analog converter 17 and output to the speaker 16. The speaker 16 is controlled based on the control signal u0, and the canceling sound is output from the speaker 16.

The first estimated cancellation signal generating unit 30 generates a first estimated cancellation signal y1\hat{ } based on the control signals u0 and u1. The first estimated cancellation signal generating unit 30 includes a first secondary path filter 30a, a second secondary path filter 30b, and an adder 30c.

In the first estimated cancellation signal generating unit 30, a SAN filter is used as a secondary path filter C\hat{ }. The secondary path filter coefficient updating unit 40, which will be described later, updates a coefficient (C0\hat{ }+iC1\hat{ }) of the secondary path filter C\hat{ }. Thus, a secondary path transfer characteristic C is identified as the secondary path filter C\hat{ }.

The first secondary path filter 30a has a filter coefficient C0\hat{ } which is a real part of a coefficient of the secondary path filter C\hat{ }. The second secondary path filter 30b has a filter coefficient C1\hat{ } which is an imaginary part of the coefficient of the secondary path filter C\hat{ }. The control signal u0 corrected by the first secondary path filter 30a and the control signal u1 corrected by the second secondary path filter 30b are added by the adder 30c to generate the first estimated cancellation signal y1\hat{ }. The first estimated cancellation signal y1\hat{ } is an estimation signal of a signal corresponding to a canceling sound y input to the microphone 22.

The estimated noise signal generating unit 32 generates an estimated noise signal d\hat{ } based on the basic signals xc and xs. The estimated noise signal generating unit 32 includes a first primary path filter 32a, a second primary path filter 32b, and an adder 32c.

In the estimated noise signal generating unit 32, a SAN filter is used as a primary path filter H\hat{ }. The primary path filter coefficient updating unit 38, which will be described later, updates a coefficient (H0\hat{ }+iH1\hat{ }) of the primary path filter H\hat{ }. Accordingly, a transfer characteristic H of the primary path (hereinafter, referred to as a primary path transfer characteristic H) is identified as a primary path filter H\hat{ }.

The first primary path filter 32a has a filter coefficient H0\hat{ } that is a real part of the coefficient of the primary path filter H\hat{ }. The second primary path filter 32b has a filter coefficient −H1\hat{ } obtained by inverting the polarity of the imaginary part of the coefficient of the primary path filter H\hat{ }. The basic signal xc corrected by the first primary path filter 32a and the basic signal xs corrected by the second primary path filter 32b are added by the adder 32c to generate the estimated noise signal d\hat{ }. The estimated noise signal d\hat{ } is an estimated signal of a signal corresponding to the noise d input to the microphone 22.

The reference signal generating unit 34 generates reference signals r0 and r1 based on the basic signals xc and xs. The reference signal generating unit 34 includes a third secondary path filter 34a, a fourth secondary path filter 34b, a fifth secondary path filter 34c, a sixth secondary path filter 34d, an adder 34e, and an adder 34f.

In the reference signal generating unit 34, a SAN filter is used as the secondary path filter C\hat{ }.

The third secondary path filter 34a has a filter coefficient C0\hat{ } which is a real part of a coefficient of the secondary path filter C\hat{ }. The fourth secondary path filter 34b has a filter coefficient −C1\hat{ } obtained by inverting the polarity of the imaginary part of the coefficient of the secondary path filter C\hat{ }. The fifth secondary path filter 34c has a filter coefficient C0\hat{ } which is a real part of a coefficient of the secondary path filter C\hat{ }. The sixth secondary path filter 34d has a filter coefficient C1\hat{ } which is an imaginary part of the coefficient of the secondary path filter C\hat{ }.

The basic signal xc corrected by the third secondary path filter 34a and the basic signal xs corrected by the fourth secondary path filter 34b are added by the adder 34e to generate the reference signal r0. The basic signal xs corrected by the fifth secondary path filter 34c and the basic signal xc corrected by the sixth secondary path filter 34d are added by the adder 34f to generate the reference signal r1.

The second estimated cancellation signal generating unit 36 generates a second estimated cancellation signal y2\hat{ } based on the reference signals r0 and r1. The second estimated cancellation signal generating unit 36 includes a fifth control filter 36a, a sixth control filter 36b, and an adder 36c.

In the second estimated cancellation signal generating unit 36, a SAN filter is used as the control filter W. The fifth control filter 36a has a filter coefficient W0. The sixth control filter 36b has a filter coefficient W1.

The reference signal r0 on which signal processing has been performed by the fifth control filter 36a and the reference signal r1 on which signal processing has been performed by the sixth control filter 36b are added by the adder 36c to generate the second estimated cancellation signal y2\hat{ }. The second estimated cancellation signal y2\hat{ } is an estimation signal of a signal corresponding to a canceling sound y input to the microphone 22.

The analog-to-digital converter 44 converts the error signal e output from the microphone 22 from an analog signal to a digital signal.

The error signal e is input to an adder 46. The polarity of the estimated noise signal d\hat{ } generated by the estimated noise signal generating unit 32 is inverted by an inverter 48, and the estimated noise signal d\hat{ } is input to the adder 46. The polarity of the first estimated cancellation signal y1\hat{ } generated by the first estimated cancellation signal generating unit 30 is inverted by an inverter 50, and the first estimated cancellation signal y1\hat{ } is input to the adder 46. In the adder 46, a first virtual error signal e1 is generated. The adder 46 corresponds to a first virtual error signal generating unit of the present invention.

The estimated noise signal d\hat{ } generated by the estimated noise signal generating unit 32 is input to an adder 52. The second estimated cancellation signal y2\hat{ } generated by the second estimated cancellation signal generating unit 36 is input to the adder 52. In the adder 52, a second virtual error signal e2 is generated. The adder 52 corresponds to a second virtual error signal generating unit of the present invention.

The primary path filter coefficient updating unit 38 sequentially and adaptively updates the coefficient of the primary path filter H\hat{ } based on the LMS algorithm such that the magnitude of the first virtual error signal e1 is minimized. The primary path filter coefficient updating unit 38 includes a first primary path filter coefficient updating unit 38a and a second primary path filter coefficient updating unit 38b.

The first primary path filter coefficient updating unit 38a and the second primary path filter coefficient updating unit 38b update the filter coefficients H0\hat{ } and H1\hat{ } based on the following expressions. In the expressions, n denotes the number of time steps (time step number, n=0, 1, 2, . . . ) and μ0 and μ1 denote the step size parameters. The active noise control device 100 performs signal processing at predetermined periods. The time step indicates the length of each period. The time step number indicates how many periods (times) the signal processing is performed.

H0\hat{ }ₙ₊₁=H0\hat{ }ₙ−μ0×e1ₙ×xcₙ

H1\hat{ }ₙ₊₁=H1\hat{ }ₙ−μ1×e1ₙ×xsₙ

In the primary path filter coefficient updating unit 38, the filter coefficients H0\hat{ } and H1\hat{ } are repeatedly updated. Thus, the primary path transfer characteristic H is identified as a primary path filter H\hat{ }. In the active noise control device 100 using the SAN filter, the update expression for the coefficient of primary path filter H\hat{ } is configured by four arithmetic operations and does not include a convolution operation. Therefore, it is possible to suppress a computation load due to update processing of the filter coefficients H0\hat{ } and H1\hat{ }.

The secondary path filter coefficient updating unit 40 sequentially and adaptively updates the coefficient of the secondary path filter C\hat{ } based on the LMS algorithm such that the magnitude of the first virtual error signal e1 is minimized. The secondary path filter coefficient updating unit 40 includes a first secondary path filter coefficient updating unit 40a and a second secondary path filter coefficient updating unit 40b.

The first secondary path filter coefficient updating unit 40a and the second secondary path filter coefficient updating unit 40b update the filter coefficients C0\hat{ } and C1\hat{ } based on the following expressions. In the expression, μ2 and μ3 indicate step size parameters.

C0\hat{ }ₙ₊₁=C0\hat{ }ₙ-μ2×e1ₙ×μ0ₙ

C1\hat{ }ₙ₊₁=C1\hat{ }ₙ−μ3×e1ₙ×μ1ₙ

In the secondary path filter coefficient updating unit 40, the filter coefficients C0\hat{ } and C1\hat{ } are repeatedly updated. Thus, a secondary path transfer characteristic C is identified as the secondary path filter C\hat{ }. In the active noise control device 100 using the SAN filter, the update expressions for the filter coefficients C0\hat{ } and C1\hat{ } are configured by four arithmetic operations and do not include a convolution operation. Therefore, it is possible to suppress the computation load due to the update processing of the filter coefficients C0\hat{ } and C1\hat{ }.

The control filter coefficient updating unit 42 sequentially and adaptively updates the coefficients W0 and W1 of the control filter W based on the LMS algorithm such that the magnitude of the second virtual error signal e2 is minimized. The control filter coefficient updating unit 42 includes a first control filter coefficient updating unit 42a and a second control filter coefficient updating unit 42b.

The first control filter coefficient updating unit 42a and the second control filter coefficient updating unit 42b update the filter coefficients W0 and W1 based on the following expressions. In the expressions, μ4 and μ5 denote the step size parameters.

W0ₙ₊₁=W0ₙ−μ4×e2ₙ×r0ₙ

W1ₙ₊₁=W1ₙ−μ5×e2ₙ×r1ₙ

In the control filter coefficient updating unit 42, the filter coefficients W0 and W1 are repeatedly updated. Thus, the control filter W is optimized. In the active noise control device 100 using the SAN filter, the update expressions for the filter coefficients W0 and W1 are configured by four arithmetic operations and do not include a convolution operation. Therefore, it is possible to suppress the computation load due to the update processing of the filter coefficients W0 and W1.

The noise to be canceled by the active noise control device 100 is a muffled sound of the engine. The muffled sound of the engine is mainly generated in a range of 40 [Hz] to 200 [Hz]. When the frequencies (control target frequencies f) detected by the frequency detecting circuit 26a are within a defined range (for example, 40 [Hz] to 200 [Hz]), the active noise control device 100 generates the control signal u0 and causes the speaker 16 to output the canceling sound.

### [Improvement Points]

Improvements made in the present invention will be described, with respect to the active noise control device 100 using the technique that was already proposed by the present inventors.

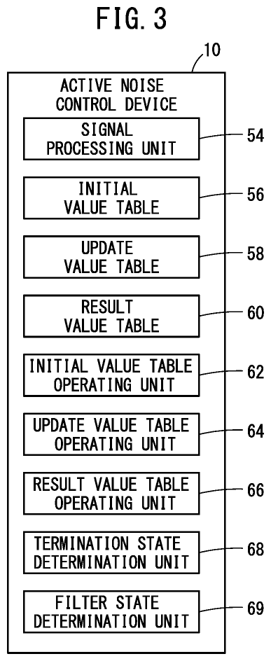

FIG. 3 is a block diagram of the active noise control device 10 according to the present embodiment. The configuration of a signal processing unit 54 of the active noise control device 10 according to the present embodiment, is substantially the same as the configuration of the active noise control device 100 described above. The active noise control device 10 further includes an initial value table 56, an update value table 58, a result value table 60, an initial value table operating unit 62, an update value table operating unit 64, a result value table operating unit 66, a termination state determination unit 68 and a filter state determination unit 69.

The active noise control device 10 includes an operational processing device and a storage unit (not shown). The operational processing device includes, for example, a processor such as a central processing unit (CPU) or a microprocessing unit (MPU), and a memory such as a ROM or a RAM. The storage unit is, for example, a hard disk, a flash memory, or the like. The active noise control device 10 need not necessarily have a storage unit. In this case, data may be transmitted and received via communications between the active noise control device 10 and the storage space on the cloud. The signal processing unit 54, the initial value table operating unit 62, the update value table operating unit 64, the result value table operating unit 66, the termination state determination unit 68, and the filter state determination unit 69 are realized by the operational processing unit executing a program stored in the storage unit.

The initial value table 56 is a memory area in table form provided in the ROM. In the initial value table 56, initial values of the filter coefficients C0\hat{ } and C1\hat{ } of a secondary path filter C\hat{ }, which will be described later, are stored. The update value table 58 is a memory area in table form provided in the RAM. In the update value table 58, the update values of the filter coefficients C0\hat{ } and C1\hat{ } are stored. The result value table 60 is a memory area in table format provided in the ROM. In the result value table 60, the result values of the filter coefficients C0\hat{ } and C1\hat{ } are stored.

The initial value table operating unit 62 writes initial values in the initial value table 56, or performs other operations. The update value table operating unit 64 writes update values in the update value table 58, or performs other operations. The result value table operating unit 66 writes result values in the result value table 60, or performs other operations.

The termination state determination unit 68 determines a cause for termination of active noise control. When one of the following three termination causes occurs, the active noise control is terminated. The three causes for termination are stopping of the engine 18, occurrence of an abnormality in active noise control, and divergence of the active noise control. When the active noise control is ended due to the stop of the engine, the termination state determination unit 68 determines that the active noise control is normally ended. When the active noise control is ended due to the occurrence of an abnormality in the active noise control, the termination state determination unit 68 determines that the active noise control ends abnormally. When the active noise control is ended due to the divergence of the active noise control, the termination state determination unit 68 determines that the active noise control ends abnormally.

The filter state determination unit 69 determines the state of the control filter W each time the filter coefficients W0 and W1 of the control filter W are updated. The filter state determination unit 69 corresponds to a state determination unit of the present invention. The determination of the state of the control filter W will be described later in detail.

The update processing of the filter coefficients C0\hat{ } and C1\hat{ } by the secondary path filter coefficient updating unit 40 of the present embodiment is partially different from the update processing of the filter coefficients C0\hat{ } and C1\hat{ } by the secondary path filter coefficient updating unit 40 of the above-described active noise control device 100.

In the secondary path filter coefficient updating unit 40 of the active noise control device 100, the first secondary path filter coefficient updating unit 40a and the second secondary path filter coefficient updating unit 40b respectively update the filter coefficients C0\hat{ } and C1\hat{ } based on the following expressions.

C0\hat{ }ₙ₊₁=C0\hat{ }ₙ−μ2×e1ₙ×u0ₙ

C1\hat{ }ₙ₊₁=C1\hat{ }ₙ−μ3×e1ₙ×u1ₙ

On the other hand, in the secondary path filter coefficient updating unit 40 of the signal processing unit 54 according to the present embodiment, the first secondary path filter coefficient updating unit 40a and the second secondary path filter coefficient updating unit 40b respectively update the filter coefficients C0\hat{ } and C1\hat{ } based on the following expressions.

C0\hat{ }(f)ₙ₊₁=C0\hat{ }(f)_u−μ2×e1ₙ×u0ₙ

C1\hat{ }(f)ₙ₊₁=C1\hat{ }(f)_u−μ3×e1ₙ×u1ₙ

Update values corresponding to the control target frequency f stored in the update value table 58 are input to the coefficients C0\hat{ } (f)_u and C1\hat{ } (f)_u in the above expressions. Hereinafter, the first terms on the right side of the update expressions of the filter coefficients C0\hat{ } and C1\hat{ } may be referred to as previous values.

In the method that was already proposed, the filter coefficients C0\hat{ } n and C1\hat{ } n updated in the previous period (time step number n) are used as previous values of the update expressions. That is, even if the control target frequency f has changed between the updating in the previous period (time step number n) and the update in the current period (time step number n+1), the filter coefficients C0\hat{ } n and C1\hat{ } n updated in the previous period are used as previous values of the update expressions.

On the other hand, in the present embodiment, an update value corresponding to the control target frequency f at the time of updating in the current period (time step number n+1) is used as the previous value of the update expression. That is, in the case of the control target frequency f, the filter coefficients C0\hat{ } (f)_u and C1\hat{ } (f)_u having the latest updating timing among the updated filter coefficients are used as the previous values of the update expressions. In other words, in the present embodiment, the previous value is not limited to a value updated last time (time step number n).

The secondary path filter coefficient updating unit 40 copies the updated filter coefficients C0\hat{ } and C1\hat{ } in the third secondary path filter 34a, the fourth secondary path filter 34b, the fifth secondary path filter 34c, and the sixth secondary path filter 34d of the reference signal generating unit 34.

### [Update of Secondary Path Filter]

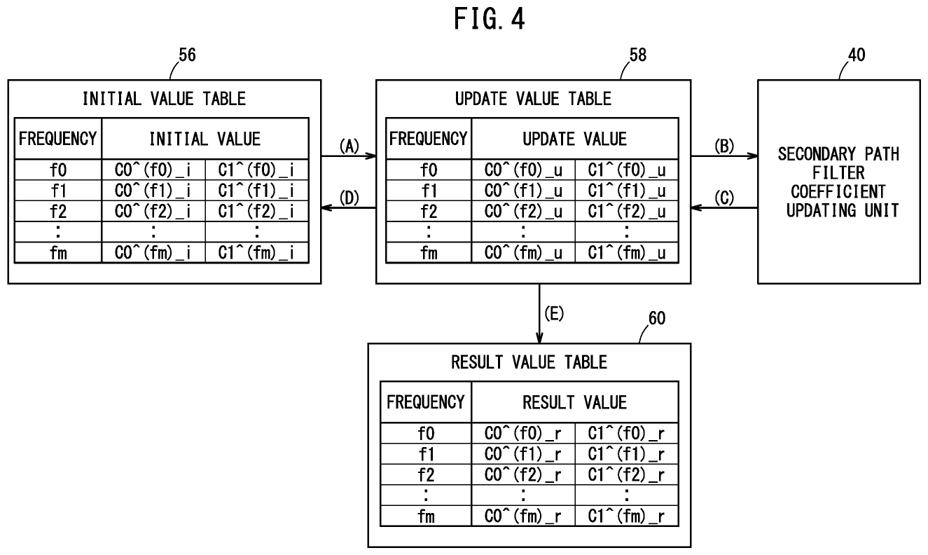

FIG. 4 is a diagram illustrating the updating of the filter coefficients C0\hat{ } and C1\hat{ }. As shown in FIG. 4, the initial value table 56 stores initial values C0\hat{ } (f)_i and C1\hat{ } (f)_i in table form in association with frequencies. The update value table 58 stores the update values C0\hat{ } (f)_u and C1\hat{ } (f)_u in table form in association with frequencies. Further, the result value table 60 stores the result values C0\hat{ } (f)_r and C1\hat{ } (f)_r in table form in association with frequencies.

The initial values stored in the initial value table 56 in association with frequencies are set based on any of the following (i) to (vi).
(i) A measured value of the secondary path transfer characteristic C at each frequency;
(ii) Phase information of a measured value of the secondary path transfer characteristic C at each frequency;
(iii) An estimated value of the secondary path transfer characteristic C complemented based on the measured values of the secondary path transfer characteristics C at representative frequencies;
(iv) Phase information of an estimated value of the secondary path transfer characteristic C complemented based on measured values of the secondary path transfer characteristics C at representative frequencies;
(v) An estimated value of the secondary path transfer characteristic C estimated by the following expressions:

C0\hat{ }(f)=α(f)×cos(−2πfT)

C1\hat{ }(f)=α(f)×sin(−2πfT)

Here, T is the time until the sound reaches the microphone 22 from the speaker 16, and a is an amplitude constant; and
(vi) A convenient small value (in a case where an initial value is not particularly set for convenience such as efficiency of system setting).

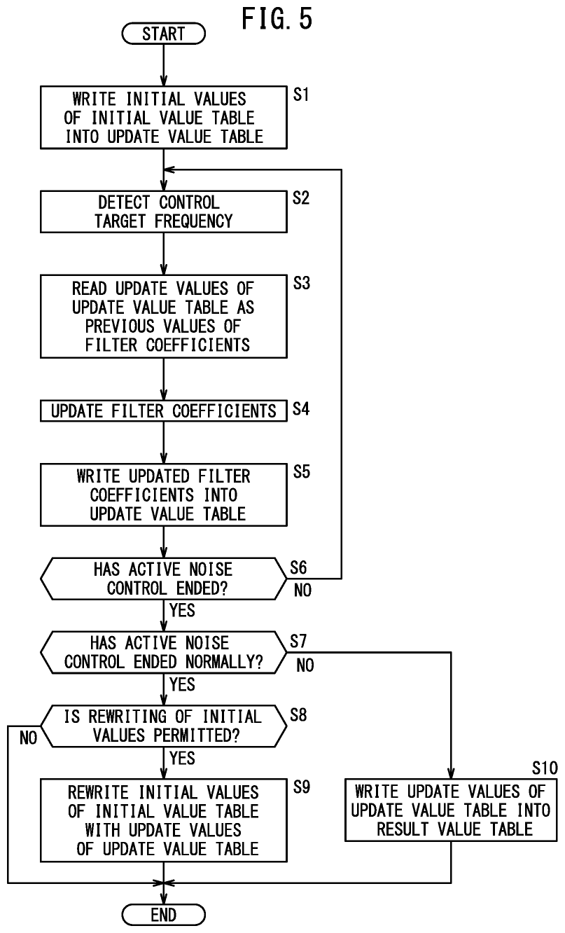

FIG. 5 is a flowchart showing a flow of update processing of the filter coefficients C0\hat{ } and C1\hat{ }. The process of updating the filter coefficients C0\hat{ } and C1\hat{ } is executed each time active noise control is performed.

In step S1, the update value table operating unit 64 rewrites the initial values corresponding to the respective frequencies of the initial value table 56 with the update values corresponding to the respective frequencies of the update value table 58 ((A) in FIG. 4). Thereafter, the process proceeds to step S2.

In step S2, the frequency detecting circuit 26a provided in the signal processing unit 54 detects the control target frequency f. Thereafter, the process proceeds to step S3.

In step S3, the secondary path filter coefficient updating unit 40 reads update values corresponding to the control target frequency f as previous values ((B) in FIG. 4). Thereafter, the process proceeds to step S4.

In step S4, the secondary path filter coefficient updating unit 40 updates the filter coefficients C0\hat{ } and C1\hat{ }. Thereafter, the process proceeds to step S5.

In step S5, the update value table operating unit 64 writes the updated filter coefficients C0\hat{ } and C1\hat{ } to the update values corresponding to the control target frequency f ((C) in FIG. 4). Thereafter, the process proceeds to step S6.

In step S6, the termination state determination unit 68 determines whether or not the active noise control has ended. If the active noise control has not terminated, the process returns to step S2, and if the active noise control has terminated, the process proceeds to step S7.

In step S7, the termination state determination unit 68 determines whether or not the active noise control has ended normally. When it is determined that the active noise control has ended normally, the process proceeds to step S8. When it is determined that the active noise control has ended abnormally, or when it is determined that the active noise control has ended in divergence, the process proceeds to step S10.

In step S8, the initial value table operating unit 62 determines whether or not rewriting of the initial values of the initial value table 56 is permitted. If the rewriting of the initial value table 56 is permitted, the process proceeds to step S9, and otherwise if rewriting of the initial value table 56 is not permitted, the update processing of the filter coefficients C0\hat{ } and C1\hat{ } is terminated.

In step S9, the initial value table operating unit 62 rewrites the initial values corresponding to the respective frequencies of the initial value table 56 with the update values corresponding to the respective frequencies of the update value table 58 ((D) in FIG. 4). Thereafter, the update processing of the filter coefficients C0\hat{ } and C1\hat{ } is terminated.

In step S10, the result value table operating unit 66 writes the update values corresponding to the respective frequencies of the update value table 58 in the result values corresponding to the respective frequencies of the result value table 60 ((E) in FIG. 4). Thereafter, the update processing of the filter coefficients C0\hat{ } and C1\hat{ } is terminated.

The initial value table 56 and the result value table 60 can be copied to a personal computer or the like connected to the vehicle 12. This makes it possible to compare the update values stored in the initial value table 56 with the result values stored in the result value table 60. Therefore, it is possible to verify the cause for the abnormality in the active noise control or the cause for the divergence of the active noise control.

### [Filter State Determination Process]

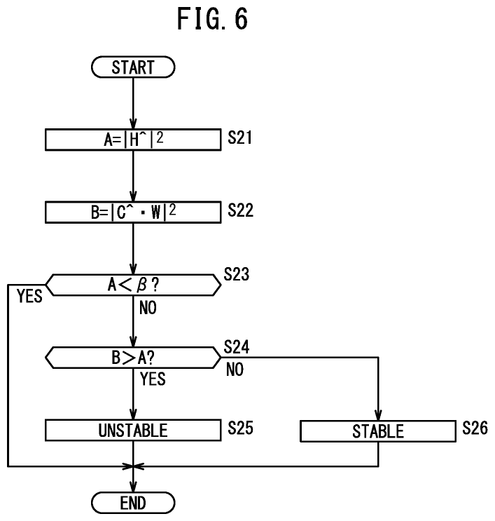

FIG. 6 is a flowchart illustrating the flow of a filter state determination process executed by the filter state determination unit 69. The filter state determination process is executed each time the control filter W is updated.

In step S21, the filter state determination unit 69 calculates a magnitude A of the primary path filter H\hat{ }. Thereafter, the process proceeds to step S22. The magnitude A can also be referred to as an amplitude characteristic of the primary path filter H\hat{ }. The magnitude A of the primary path filter H\hat{ } can be obtained by the following expression.

A=|H\hat{ }|²=H0\hat{ }²+H1\hat{ }²

In step S22, the filter state determination unit 69 calculates a magnitude B of the filter characteristic obtained by coupling the secondary path filter C\hat{ } and the control filter W in series, and proceeds to step S23. The magnitude B indicates an amplitude characteristic among filter characteristics in which the secondary path filter C\hat{ } and the control filter W are coupled in series. The magnitude B can be obtained by the following expression.

B=|C\hat{ }·W|²=(C0\hat{ }·W0+C1\hat{ }·W1)²+(C0\hat{ }·W1−C1\hat{ }·W0)²

Note that the signal processing unit 54 may use, as the filter coefficients C0 and C1 of the secondary path filter C\hat{ }, those normalized by the magnitude |C\hat{ }| of the secondary path filter C\hat{ }. In this case, the magnitude B is obtained by the following expression.

B=|W|²=W0²+W1²

In step S23, the filter state determination unit 69 determines whether or not the magnitude A is smaller than a predetermined value β. When the magnitude A is smaller than the predetermined value β, the filter state determination process is terminated, and when the magnitude A is equal to or larger than the predetermined value β, the process proceeds to step S24.

In step S24, the filter state determination unit 69 determines whether or not the magnitude B is larger than the magnitude A. When the magnitude B is larger than the magnitude A, the process proceeds to step S25, and when the magnitude B is equal to or smaller than the magnitude A, the process proceeds to step S26.

In step S25, the filter state determination unit 69 determines that the state of the control filter W is unstable. Thereafter, the filter state determination process is terminated.

In step S26, the filter state determination unit 69 determines that the state of the control filter W is stable. Thereafter, the filter state determination process is terminated.

When it is determined that the state of control filter W is unstable, the active noise control device 10 stops active noise control.

### [Operational Effects]

The active noise control device 10 of the present embodiment is provided with the initial value table 56 and the update value table 58. Accordingly, the active noise control device 10 can set initial values of filter coefficients C0\hat{ } and C1\hat{ } for each of frequencies. Further, the active noise control device 10 can update filter coefficients C0\hat{ } and C1\hat{ } for each of frequencies. Therefore, the active noise control device 10 can significantly improve the initial silencing performance, particularly after the start of active noise control. However, the secondary path filter C\hat{ } may converge on a characteristic that is significantly different from the actual secondary path transfer characteristic C. In this case, the active noise control device 10 cannot generate a control signal u0 corresponding to the secondary path transfer characteristic C. Therefore, the noise cannot be sufficiently canceled by the canceling sound output from the speaker 16. In particular, when the phase characteristic of the secondary path filter C\hat{ } has a phase difference of 90° or more with respect to the phase characteristic of the actual secondary path transfer characteristic C, the control filter W diverges. When the control filter W diverges, the active noise control device 10 stops the active noise control. However, immediately before the active noise control is stopped, an abnormal sound is output from the speaker 16 undesirably.

Therefore, in the active noise control device 10 of the present embodiment, the filter state determination unit 69 compares the magnitude of the primary path filter H\hat{ } with the magnitude of the control filter W. The filter state determination unit 69 determines whether or not the state of the control filter W is unstable based on the comparison result. Thus, when it is determined that the state of control filter W is unstable, the active noise control device 10 can stop active noise control before the control filter W diverges. Therefore, the active noise control device 10 can suppress an abnormal sound from being output from the speaker 16 due to divergence of control filter W.

Further, in the active noise control device 10 of the present embodiment, the filter state determination unit 69 determines that the state of control filter W is unstable in the following cases. The following case is a case where the magnitude A of the filter characteristic obtained by coupling the secondary path filter C\hat{ } and the control filter W in series is larger than the magnitude B of the primary path filter H\hat{ }. The magnitude A=|C\hat{ }·W|. Further, the magnitude B=|H\hat{ }|. As can be seen from the block diagram of FIG. 2, when the active noise control is normally performed, H\hat{ }=C\hat{ }·W is established. When the magnitude A is larger than the magnitude B, the canceling sound is output more than necessary with respect to the magnitude of the noise. Therefore, it is determined that the state of the control filter W is unstable. Thus, in the active noise control device 10, the filter state determination unit 69 can accurately determine the state of the control filter W.

Further, in the active noise control device 10 of the present embodiment, the filter state determination unit 69 does not determine the state of control filter W when the magnitude of the primary path filter H\hat{ } is less than the predetermined value. Immediately after the active noise control starts, the magnitudes of the primary path filter H\hat{ }, the secondary path filter C\hat{ }, and the control filter W are all small. In this state, even if the filter state determination unit 69 attempts to determine the state of the control filter W, there is a risk of erroneous determination. Thus, in the active noise control device 10, the filter state determination unit 69 can suppress erroneous determination of the state of control filter W.

### Second Embodiment

In the present embodiment, when the state of the control filter W becomes unstable, the magnitude of the canceling sound output from the speaker 16 is suppressed. Two methods 1 and 2 will be described below as signal processing methods for suppressing the magnitude of the canceling sound output from the speaker 16.

### [Method 1]

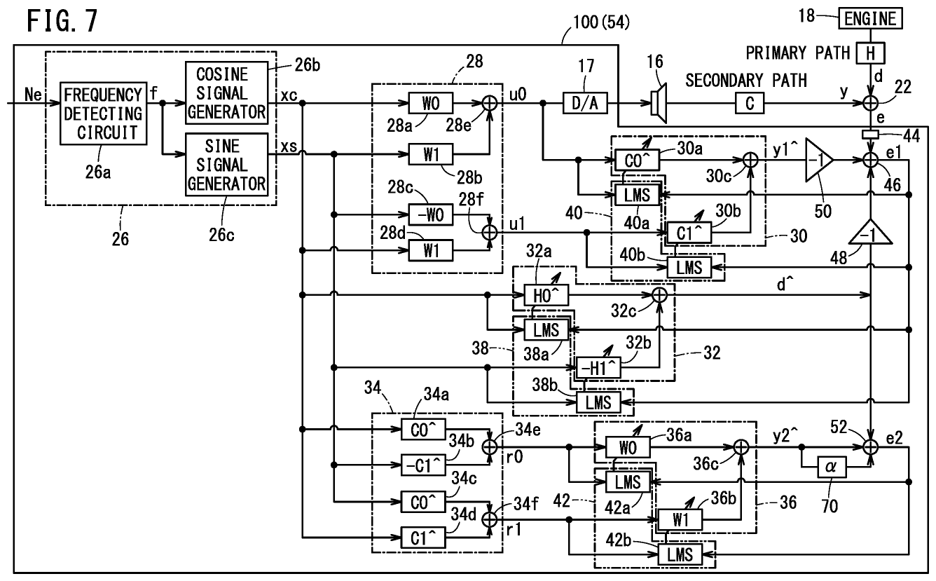

FIG. 7 is a block diagram of the signal processing unit 54. In the signal processing unit 54 of the method 1, a stabilization filter 70 is added to the signal processing unit 54 (FIG. 2) of the first embodiment. By providing the stabilization filter 70, the magnitude of the second estimated cancellation signal y2\hat{ } input to the adder 52 is multiplied by (1+α). The stabilization filter 70 is set to α=0 when it is determined that the state of the control filter W is stable. When it is determined that the state of the control filter W is unstable, the stabilization filter 70 is set such that the value of a gradually increases as time elapses. As a result, the second estimated cancellation signals y2\hat{ } input to the adder 52 can be increased by (1+α) times. Therefore, the second virtual error signals e2 generated by the adder 52 become large. This makes it possible to reduce the size of the control filter W. As a result, the magnitude of the control signal u0 is suppressed, and the magnitude of the canceling sound output from the speaker 16 can be suppressed.

### [Method 2]

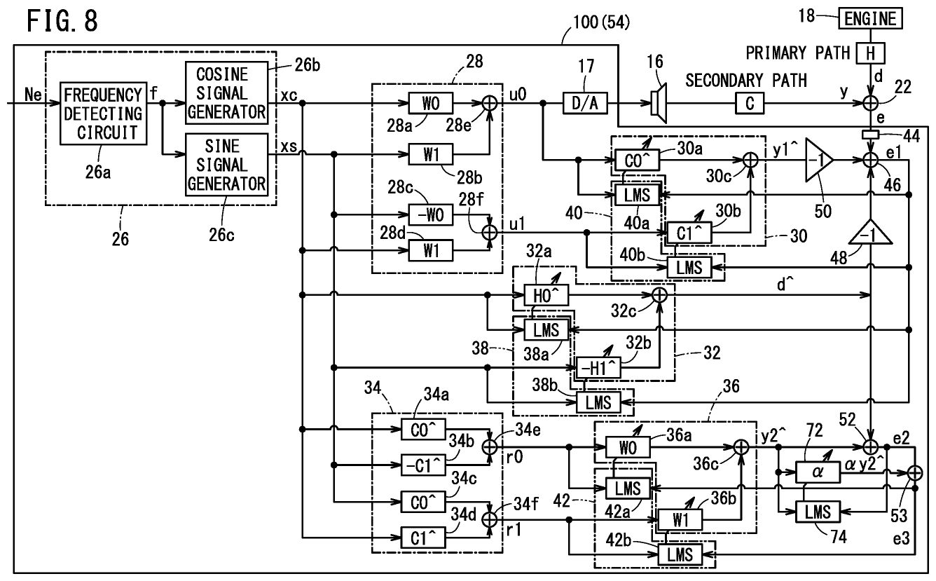

FIG. 8 is a block diagram of the signal processing unit 54. In the signal processing unit 54 of the method 2, a stabilization signal generating unit 72 is added to the signal processing unit 54 (FIG. 2) of the first embodiment. The stabilization signal generating unit 72 generates a stabilization signal αy2\hat{ }. The stabilization signal αy2\hat{ } is generated by performing signal processing on the second estimated cancellation signal y2\hat{ } with a stabilization filter, which is an adaptive filter. Further, in the signal processing unit 54 of the method 2, an adder 53 is added to the signal processing unit 54 (FIG. 2) of the first embodiment. The adder 53 generates a third virtual error signal e3 from the second virtual error signal e2 and the stabilization signal αy2\hat{ }. Further, in the signal processing unit 54 of the method 2, a stabilization filter coefficient updating unit 74 is added to the signal processing unit 54 (FIG. 2) of the first embodiment. The stabilization filter coefficient updating unit 74 sequentially and adaptively updates the filter coefficient α of the stabilization filter based on the second estimated cancellation signal y2\hat{ } and the second virtual error signal e2 such that the magnitude of the second virtual error signal e2 is minimized.

The second virtual error signal e2 generated by the adder 52 are input to the adder 53. The stabilization signal αy2\hat{ } generated by the stabilization signal generating unit 72 is input to the adder 53. In the adder 53, a third virtual error signal e3 is generated. The adder 53 corresponds to a third virtual error signal generating unit of the present invention.

The control filter coefficient updating unit 42 updates the filter coefficients W0 and W1 based on the reference signals r0 and r1 and the third virtual error signal e3.

As a result, the second estimated cancellation signal y2\hat{ } included in the third virtual error signal e3 increases by (1+α) times the second estimated cancellation signal y2\hat{ } included in the second virtual error signal e2. Therefore, the size of the control filter W can be suppressed. As a result, the magnitude of the control signal u0 is suppressed, and the magnitude of the canceling sound output from the speaker 16 can be suppressed.

### [Filter State Determination Process]

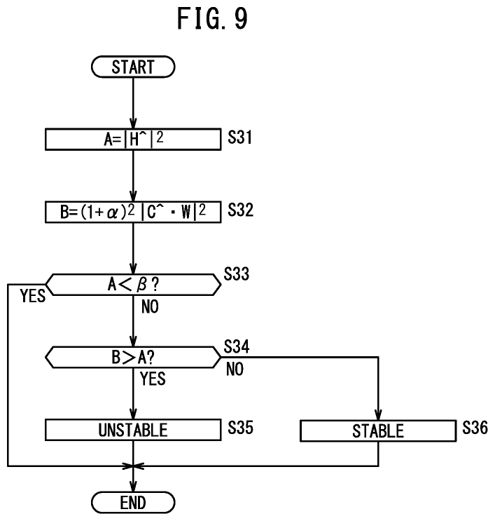

FIG. 9 is a flowchart illustrating the flow of the filter state determination process executed by the filter state determination unit 69. The filter state determination process is executed each time the control filter W is updated.

In step S31, the filter state determination unit 69 calculates a magnitude A of the primary path filter H\hat{ }. Thereafter, the process proceeds to step S32. The magnitude A can also be referred to as an amplitude characteristic of the primary path filter H\hat{ }. The magnitude A can be obtained by the following expression.

A=|H\hat{ }|²=H0\hat{ }²+H1\hat{ }²

In step S32, the filter state determination unit 69 calculates a magnitude B of the filter characteristic obtained by coupling the secondary path filter C\hat{ } and the control filter W in series. Thereafter, the process proceeds to step S33. The magnitude B indicates an amplitude characteristic among filter characteristics in which the secondary path filter C\hat{ } and the control filter W are coupled in series. The magnitude B can be obtained by the following expression.

B=(1+α)²|C\hat{ }·W|²=(1+α)²(C0\hat{ }·W0+C1\hat{ }·W1)²+(1+α)²(C0\hat{ }·W1−C1\hat{ }·W0)²

Note that the signal processing unit 54 may use, as the filter coefficients COA and C1\hat{ } of the secondary path filter C\hat{ }, those normalized by the magnitude |C\hat{ }| of the secondary path filter C\hat{ }. In this case, the magnitude B is obtained by the following expression.

B=(1+α)²|W|²=(1+α)²W0²+(1+α)²W1²

In step S33, the filter state determination unit 69 determines whether or not the magnitude A is smaller than a predetermined value β. When the magnitude A is smaller than the predetermined value β, the filter state determination process is terminated. When the magnitude A of the primary path filter H\hat{ } is equal to or larger than the predetermined value β, the process proceeds to step S34.

In step S34, the filter state determination unit 69 determines whether or not the magnitude B is larger than the magnitude A. When the magnitude B is larger than the magnitude A, the process proceeds to step S35. When the magnitude B is equal to or smaller than the magnitude A, the process proceeds to step S36.

In step S35, the filter state determination unit 69 determines that the state of the control filter W is unstable. Thereafter, the filter state determination process is terminated.

In step S36, the filter state determination unit 69 determines that the state of the control filter W is stable. Thereafter, the filter state determination process is terminated.

In the case of the above-described method 1, when it is determined that the state of the control filter W is stable, the signal processing unit 54 sets the stabilization filter coefficient α=0. When it is determined that the state of the control filter W is unstable, the value of the filter coefficient α is set so as to gradually increase as time elapses.

### [Operational Effects]

The active noise control device 10 of the present embodiment has the stabilization filter 70. When the filter state determination unit 69 determines that the state of the control filter W is unstable, the stabilization filter 70 corrects the second estimated cancellation signal y2\hat{ } input to the adder 52 so as to increase. As a result, the second virtual error signal e2 generated by the adder 52 increases. Therefore, the size of the control filter W can be suppressed. Therefore, when the state of the control filter W is unstable, the magnitude of the canceling sound output from the speaker 16 can be suppressed. As a result, it is possible to suppress amplification of noise and generation of abnormal sound due to the canceling sound.

Further, in the active noise control device 10 of the present embodiment, the stabilization signal generating unit 72 generates the stabilization signal αy2\hat{ }. The stabilization signal αy2\hat{ } is generated by performing signal processing on the second estimated cancellation signal y2\hat{ } with a stabilization filter, which is an adaptive notch filter. Further, the adder 53 generates the third virtual error signal e3 from the second virtual error signal e2 and the stabilization signal αy2\hat{ }. Further, the stabilization filter coefficient updating unit 74 sequentially and adaptively updates the filter coefficient α of the stabilization filter, based on the second estimated cancellation signal y2\hat{ } and the second virtual error signal e2 such that the magnitude of the second virtual error signal e2 is minimized. Further, based on the reference signals r0 and r1 and the third virtual error signal e3, the control filter coefficient updating unit 42 sequentially and adaptively updates the filter coefficients W0 and W1 of the control filter W such that the magnitude of the third virtual error signal e3 is minimized.

As a result, the third virtual error signal e3 generated by the adder 53 increases. Therefore, the magnitude of the control filter W can be suppressed. Therefore, when the state of the control filter W is unstable, the magnitude of the canceling sound output from the speaker 16 can be suppressed. As a result, it is possible to suppress amplification of noise and generation of abnormal sound due to the canceling sound.

### Third Embodiment

When the following condition is satisfied, the signal processing unit 54 of the first embodiment and the second embodiment generates the control signal u0 and causes the speaker 16 to output the canceling sound. The condition is that the control target frequency f is within a defined range (for example, 40 [Hz] to 200 [Hz]). The control target frequency f is a frequency detected by the frequency detecting circuit 26a. That is, when the control target frequency f is outside the defined range, the signal processing unit 54 according to the first and second embodiments does not generate the control signal u0. In this case, no updating of the primary path filter H\hat{ } takes place. Therefore, even after time elapses from the start of the active noise control, there may be a case where the primary path filter H\hat{ } is not updated from an initial value (for example, H0\hat{ }=0, H1\hat{ }=0). In this case, when the control target frequency f falls within the defined range and the generation of the control signal u0 is started, it may undesirably take time for the control filter W to converge.

The signal processing unit 54 according to the present embodiment continues the generation of the control signal u0 and the updating of the primary path filter H\hat{ } even when the control target frequency f is outside the defined range.

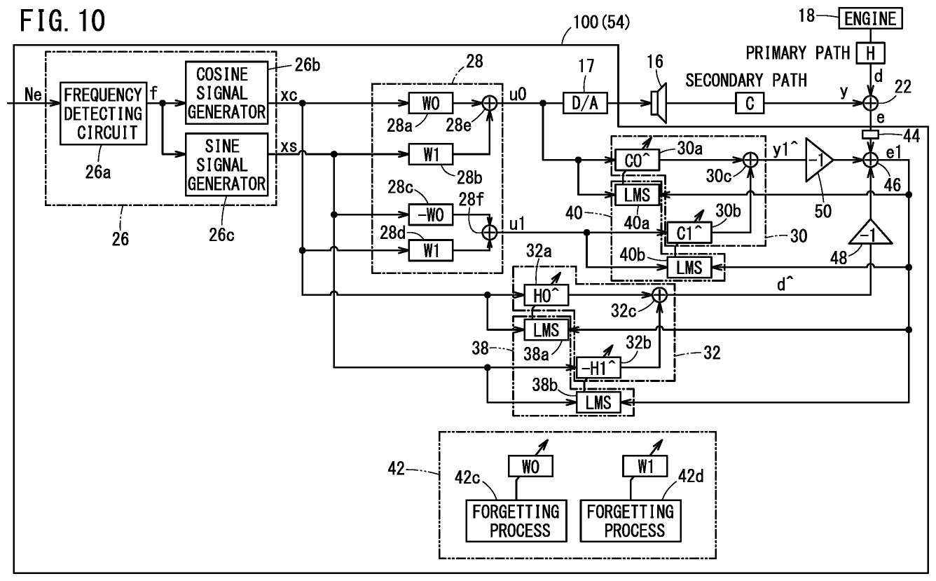

FIG. 10 is a block diagram of the signal processing unit 54 used when the control target frequency f is outside the defined range. In the signal processing unit 54 shown in FIG. 10, the reference signal generating unit 34, the second estimated cancellation signal generating unit 36, and the adder 52 are deleted from the signal processing unit 54 shown in FIG. 2. Further, the configuration of the control filter coefficient updating unit 42 is different.

The control filter coefficient updating unit 42 includes a third control filter coefficient updating unit 42c and a fourth control filter coefficient updating unit 42d. The third control filter coefficient updating unit 42c performs forgetting process on the control filter coefficient W0. The fourth control filter coefficient updating unit 42d performs forgetting process on the control filter coefficient W1. The forgetting process is a process of gradually decreasing the control filter coefficient W0 and the control filter coefficient W1 by multiplying each of the control filter coefficient W0 and the control filter coefficient W1 by a forgetting coefficient (for example, 0.999).

This makes it possible to reduce the magnitude of the control filter W while continuing the updating of the primary filter H\hat{ } even when the control target frequency f is outside the defined range. Therefore, when the control target frequency f is out of the defined range, the canceling sound output from the speaker 16 can be faded out. Further, when the control target frequency f falls within the defined range from outside the defined range, the initial value of the control filter W is set to H\hat{ }/C\hat{ }. As a result, convergence of the control filter W can be accelerated, and performance of the active noise control device 10 can be transiently improved.

[Technical Invention Obtained from Embodiments]

The invention that can be grasped from the above embodiments will be described below.

The active noise control device (10) according to the present invention perform active noise control for controlling a speaker (16) based on an error signal that changes in accordance with a synthetic sound of noise transmitted from a vibration source and a canceling sound output from the speaker to cancel the noise, and includes the basic signal generating unit (26) configured to generate a basic signal corresponding to a control target frequency, the control signal generating unit (28) configured to perform signal processing on the basic signal by a control filter, which is an adaptive notch filter, to generate a control signal that controls the speaker, the first estimated cancellation signal generating unit (30) configured to perform signal processing on the control signal by a secondary path filter, which is an adaptive notch filter, to generate a first estimated cancellation signal, the estimated noise signal generating unit (32) configured to perform signal processing on the basic signal by a primary path filter, which is an adaptive notch filter, to generate an estimated noise signal, the reference signal generating unit (34) configured to perform signal processing on the basic signal by the secondary path filter to generate a reference signal, the second estimated cancellation signal generating unit (36) configured to perform signal processing on the reference signal by the control filter to generate a second estimated cancellation signal, the first virtual error signal generating unit (46) configured to generate a first virtual error signal from the error signal, the first estimated cancellation signal, and the estimated noise signal, the second virtual error signal generating unit (52) configured to generate a second virtual error signal from the estimated noise signal and the second estimated cancellation signal, the secondary path filter coefficient updating unit (40) configured to sequentially and adaptively update a coefficient of the secondary path filter based on the control signal and the first virtual error signal in a manner that a magnitude of the first virtual error signal is minimized, the control filter coefficient updating unit (42) configured to sequentially and adaptively update a coefficient of the control filter based on the reference signal and the second virtual error signal in a manner that a magnitude of the second virtual error signal is minimized, and the state determination unit (69) configured to compare a magnitude of the primary path filter with a magnitude of at least the control filter to determine whether a state of the control filter is unstable.

In the active noise control device according to the present invention, the state determination unit may be configured to determine that the state of the control filter is unstable if a magnitude of a filter in which the control filter and the secondary path filter are coupled in series is larger than a magnitude of the primary path filter.

In the active noise control device according to the present invention, the state determination unit need not necessarily determine the state of the control filter if the magnitude of at least the primary path filter is less than a predetermined value.

The active noise control device according to the present invention may further include the stabilization filter (70) configured to correct a magnitude of the second estimated cancellation signal input to the second virtual error signal generating unit so as to be increased if the state determination unit determines that the state of the control filter is unstable.

The active noise control device according to the present invention may further include the stabilization signal generating unit (72) configured to perform signal processing on the second estimated cancellation signal by a stabilization filter, which is an adaptive filter, to generate a stabilization signal, the third virtual error signal generating unit (53) configured to generate a third virtual error signal from the second virtual error signal and the stabilization signal, and the stabilization filter coefficient updating unit (74) configured to sequentially and adaptively update a coefficient of the stabilization filter based on the second estimated cancellation signal and the second virtual error signal in a manner that the magnitude of the second virtual error signal is minimized, wherein the control filter coefficient updating unit is configured to sequentially and adaptively update the coefficient of the control filter based on the reference signal and the third virtual error signal in a manner that a magnitude of the third virtual error signal is minimized.

The active noise control device according to the present invention may further include the primary path filter coefficient updating unit (38) configured to sequentially and adaptively update a coefficient of the primary path filter based on the basic signal and the first virtual error signal in a manner that the magnitude of the first virtual error signal is minimized.

The active noise control device according to the present invention may further include the primary path filter coefficient updating unit configured to sequentially and adaptively update a coefficient of the primary path filter based on the basic signal and the first virtual error signal in a manner that the magnitude of the first virtual error signal is minimized, wherein if the control target frequency is outside a predetermined range, the control filter coefficient updating unit may be configured to gradually decrease the coefficient of the control filter.

The present invention is not particularly limited to the embodiments described above, and various modifications are possible without departing from the essence and gist of the present invention.

What is claimed is:

1. An active noise control device that performs active noise control for controlling a speaker based on an error signal that changes in accordance with a synthetic sound of noise transmitted from a vibration source and a canceling sound output from the speaker to cancel the noise, the active noise control device comprising one or more processors that execute computer-executable instructions stored in a memory, wherein the one or more processors execute the computer-executable instructions to cause the active noise control device to:
generate a basic signal corresponding to a control target frequency;
perform signal processing on the basic signal by a control filter, which is an adaptive notch filter, to generate a control signal that controls the speaker;
perform signal processing on the control signal by a secondary path filter, which is an adaptive notch filter, to generate a first estimated cancellation signal;
perform signal processing on the basic signal by a primary path filter, which is an adaptive notch filter, to generate an estimated noise signal;
perform signal processing on the basic signal by the secondary path filter to generate a reference signal;
perform signal processing on the reference signal by the control filter to generate a second estimated cancellation signal;
generate a first virtual error signal from the error signal, the first estimated cancellation signal, and the estimated noise signal;
generate a second virtual error signal from the estimated noise signal and the second estimated cancellation signal;
sequentially and adaptively update a coefficient of the secondary path filter based on the control signal and the first virtual error signal in a manner that a magnitude of the first virtual error signal is minimized;
sequentially and adaptively update a coefficient of the control filter based on the reference signal and the second virtual error signal in a manner that a magnitude of the second virtual error signal is minimized; and
compare a magnitude of the primary path filter with a magnitude of at least the control filter to determine whether a state of the control filter is unstable.

2. The active noise control device according to claim 1, wherein the one or more processors cause the active noise control device to determine that the state of the control filter is unstable if a magnitude of a filter in which the control filter and the secondary path filter are coupled in series is larger than a magnitude of the primary path filter.

3. The active noise control device according to claim 1, wherein the one or more processors cause the active noise control device not to determine the state of the control filter if the magnitude of at least the primary path filter is less than a predetermined value.

4. The active noise control device according to claim 1, wherein the one or more processors cause the active noise control device to correct a magnitude of the second estimated cancellation signal so as to be increased if it is determined that the state of the control filter is unstable.

5. The active noise control device according to claim 1, wherein the one or more processors cause the active noise control device to:
perform signal processing on the second estimated cancellation signal by a stabilization filter, which is an adaptive filter, to generate a stabilization signal;
generate a third virtual error signal from the second virtual error signal and the stabilization signal;
sequentially and adaptively update a coefficient of the stabilization filter based on the second estimated cancellation signal and the second virtual error signal in a manner that the magnitude of the second virtual error signal is minimized, and
sequentially and adaptively update the coefficient of the control filter based on the reference signal and the third virtual error signal in a manner that a magnitude of the third virtual error signal is minimized.

6. The active noise control device according to claim 1, wherein the one or more processors cause the active noise control device to sequentially and adaptively update a coefficient of the primary path filter based on the basic signal and the first virtual error signal in a manner that the magnitude of the first virtual error signal is minimized.

7. The active noise control device according to claim 1, wherein the one or more processors cause the active noise control device to:
sequentially and adaptively update a coefficient of the primary path filter based on the basic signal and the first virtual error signal in a manner that the magnitude of the first virtual error signal is minimized; and
gradually decrease the coefficient of the control filter if the control target frequency is outside a predetermined range.
